(19) United States
(12) Patent Application Publication
(10) Pub. No.: US 2024/0317227 A1
(43) Pub. Date: Sep. 26, 2024

(54) METHOD AND DEVICE FOR CONTROLLING THE DISTANCE BETWEEN AN EGO-VEHICLE AND A PRECEDING VEHICLE, VEHICLE, AND ELECTRONIC PROCESSING UNIT

(71) Applicant: ZF CV SYSTEMS GLOBAL GMBH, Bern (CH)

(72) Inventors: Mathias BAUM, Hannover (DE); Hoshiyar SINGH, Hannover (DE)

(21) Appl. No.: 18/575,393

(22) PCT Filed: Jun. 2, 2022
(86) PCT No.: PCT/EP2022/065022

§ 371 Date: Dec. 29, 2023

(30) Foreign Application Priority Data
Jun. 30, 2021 (DE) 102021116853.8

(51) Int. Cl. B60W 30/17; B60W 30/18; B60W 50/14; B60W 50/16

(52) U.S. Cl. CPC B60W 30/17; B60W 30/18018; B60W 30/18027; B60W 30/181; B60W 50/16; B60W 2050/143; B60W 2050/146; B60W 2420/403; B60W 2420/408; B60W 2510/0657; B60W 2554/802

(57) ABSTRACT

A method for controlling a distance between an ego-vehicle and a vehicle ahead, wherein the ego-vehicle is equipped with at least one braking system, a drive system and an adaptive cruise control system with an operating unit, the method including maintaining an entered minimum distance that is controlled by the adaptive cruise control system wherein when the ego-vehicle is at a standstill, a reduction of the entered minimum distance is made possible by user input by the operating unit. The method further includes releasing, after operating an operating element, a holding function of the braking system and increasing a drive torque of the drive system in order to cause the ego-vehicle to accelerate in a forward direction, continuously measuring a distance to a vehicle ahead, and when a predefined reduction distance or a predefined safety distance to the vehicle ahead is reached, canceling the increase in drive torque.

### CROSS REFERENCE TO RELATED APPLICATIONS

This application is a U.S. National Phase application under 35 U.S.C. § 371 of International Application No. PCT/EP2022/065022, filed on Jun. 2, 2022, and claims benefit to German Patent Application No. DE 10 2021 116 853.8, filed on Jun. 30, 2021. The International Application was published in German on Jan. 5, 2023 as WO 2023/274657 A1 under PCT Article 21(2).

### FIELD

Embodiments of the invention relate to the technical field of vehicles equipped with a system for automatic distance control. Such distance control systems are often referred to internationally as ACC systems, corresponding to “Adaptive Cruise Control” systems. The ACC systems fall under the category of driver assistance systems. More specifically, an ACC system concerns a speed control system in motor vehicles that incorporates the distance to a vehicle ahead as an additional feedback and control variable. In this way, a safety distance can be maintained. Modern ACC systems also offer the driver a way to select the desired distance to the vehicle ahead. This can be done in an operating menu that is displayed on a display unit. To select the distance, a button on a steering wheel operating unit is often used.

### BACKGROUND

Such ACC systems increase the comfort of the driver. Especially on long motorway journeys, they can relieve the driver by freeing him from the task of frequent braking and accelerating of the vehicle in order to maintain a certain distance. However, the same applies to less fluid city traffic. Secondarily, there is also a gain in safety due to the fact that the driver tires less quickly because he does not have to concentrate as much to maintain the distance.

In addition to the so-called follow-to-stop function, some manufacturers also offer a so-called stop & go system. With the follow-to-stop function, the vehicle follows the vehicle ahead until it comes to a standstill. After the stop, however, the vehicle does not automatically start again. With the stop & go function, it is also possible to start off independently after a short standstill when the vehicle ahead starts moving again. There are also systems that only start again after a driver confirmation by tapping the accelerator pedal or pressing an operating element. This function serves to further increase driver comfort in cities and in traffic jams on the motorway.

Radar sensors are mainly used for distance measurement in today's ACC systems, lidar systems can also be used, but are not yet so widespread. Cameras are also used for better object recognition and lane recognition. The distance to the vehicle ahead can also be measured using cameras. However, this requires the use of a stereo camera.

Such ACC systems are used in various categories of vehicles. These include passenger cars, including motorcycles, camping vehicles and buses and commercial vehicles such as trucks, agricultural machines, such as tractors, combine harvesters, forage harvesters, forestry equipment, etc.

From document EP 1 437 254 A1 an ACC system with a stop & go function is known. The ACC system is designed for speeds below 50 km/h. The ACC system is equipped with a selector switch that can be used to select a desired distance to the vehicle ahead. As an example, 3 selection distances are provided. This means that the vehicle will automatically start up again if the vehicle ahead comes to a standstill but then starts moving again.

From document US 2015/0266476 A1, a vehicle start/stop system with an ACC system is known, which follows a vehicle ahead at a distance to a standstill. Then the internal combustion engine is also switched off by the start-stop system. When the vehicle ahead comes to a standstill and the accelerator pedal is pressed, and the restart conditions are met, the internal combustion engine is started and the vehicle crawls further forward to close the gap to the vehicle ahead. The restart conditions are met when the brake is not applied and the acceleration of the vehicle is requested by the ACC system or the driver.

In any case, the smallest distance to the vehicle ahead that can be set of such ACC systems is still greater than a fixed safety distance. The fixed safety distance can be 2 m, for example. This is used for safety if, for example, when stopping, the vehicle does not come to a stop until later than desired due to an extended stopping distance. For example, the smallest stopping distance that can be set can be 5 m. This distance should be maintained when the vehicle comes to a standstill. In dense city traffic, however, as is often observed, this leads to pedestrians or bicycles simply passing between stationary vehicles and thus endangering themselves. In traffic jams on the motorway, it is observed that leaving a gap of 5 m in length often leads to other vehicles in the adjacent lane entering this gap, so that the driver of the vehicle equipped with an ACC system has no choice but to take control of the vehicle himself if he is disturbed by this behavior of other road users. This leads to dissatisfaction with the ACC system on the part of the driver of the vehicle equipped with the ACC system. This can go so far that the driver even switches off the ACC system out of frustration, so that the ACC system is no longer used at all and its advantages are no longer seen at all. The driver then refrains from using the ACC system, even though the vehicle is equipped with it, because he has observed that the ACC system does not work in practice in the situations under consideration.

For the driver, the constant starting in traffic jams or in stop & go traffic is again a burden.

So there is a problem with the existing ACC systems with a stop & go function that even if the smallest distance for stop & go traffic is selected, other road users often enter the resulting gap between the ego-vehicle and the vehicle ahead, which means that the ACC system has to start a braking process in order to increase the distance back to the set minimum distance. This again creates a larger gap into which a vehicle can enter again. There is always a recurring problem with the larger gap. This prolongs the journey for the vehicle equipped with the ACC system, which can also lead to dissatisfaction on the part of the driver of the vehicle. This can also result in greater fuel consumption in the ego-vehicle. This would then also be associated with greater emissions of climate-damaging gases from vehicles with internal combustion engines.

There is a need for improvements in ACC systems with a stop & go function.

### SUMMARY

In an embodiment, the present disclosure provides a method for controlling a distance between an ego-vehicle and a vehicle ahead, wherein the ego-vehicle is equipped with at least one braking system, a drive system and an adaptive cruise control system with an operating unit, the method comprising maintaining an entered minimum distance that is controlled by the adaptive cruise control system wherein when the ego-vehicle is at a standstill, a reduction of the entered minimum distance is made possible by user input by the operating unit. The method further comprises releasing, after operating an operating element, a holding function of the braking system and increasing a drive torque of the drive system in order to cause the ego-vehicle to accelerate in a forward direction, continuously measuring a distance to a vehicle ahead, and when a predefined reduction distance or a predefined safety distance to the vehicle ahead is reached, canceling the increase in drive torque.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a illustrates the occurrence of a gap when using an ACC system with a stop & go function in the event of traffic congestion;

FIG. 1b illustrates closing the gap when using an ACC system according to an embodiment of the invention with a stop & go function in the event of traffic congestion in a first step;

FIG. 1c illustrates closing the gap when using an ACC system according to an embodiment of the invention with a stop & go function in the event of traffic congestion in a second step;

FIG. 2 illustrates a steering wheel operating unit for use with an ACC system according to an embodiment of the invention;

FIG. 3 shows a block diagram for the electronic equipment of a commercial vehicle; and

FIG. 4 shows a flowchart for a computer program for implementing a method according to an embodiment of the invention.

### DETAILED DESCRIPTION

In an embodiment, the present invention provides an improved ACC system with a stop & go function in such a way that frequent entry of other road users into the gap between the ego-vehicle and the vehicle ahead is avoided. At the same time, however, the condition must also be observed that a safety distance to the vehicle ahead of the vehicle should be maintained during all control processes of the ACC system.

In an embodiment, the invention relates to a method for controlling the distance between an ego-vehicle and a vehicle ahead. The vehicle is equipped with at least one braking system, a drive system and an adaptive cruise control system with an operating unit, and maintaining an entered minimum distance is controlled by the adaptive cruise control system. The method is characterized in that when the ego-vehicle is at a standstill, the entered minimum distance can be reduced by a user input via the operating unit. After operating an operating element, a drive torque of the drive system is increased in order to cause the ego-vehicle to accelerate in the forward direction. The distance to the vehicle ahead is measured continuously and when a predefined reduction distance is reached to close the gap to the vehicle ahead, the increase in drive torque is cancelled. It can be taken into account here that the vehicle continues to roll for a distance before it comes to a standstill. An early reduction of the increase in drive torque ensures that the safety distance is maintained. In addition, the distance to the vehicle ahead is measured further. If it is determined that the distance could become less than the safety distance, the vehicle is gently braked at an early stage. This method has the advantage that the adaptive cruise control system does not have to offer even smaller minimum distances to choose from, which are relatively close to the safety distance that must be maintained. Their application would entail the risk of temporarily falling below the safety distance if this distance were used outside the range of walking speed. However, this danger exists even in traffic situations with traffic jams, where vehicles drive faster than desired in order to fill gaps in the traffic flow that arise again and again. The method offers the advantage that the driver of the vehicle is offered the opportunity to close the occurring gap to the vehicle ahead when the vehicle ahead comes to a standstill in a traffic jam, when it comes to a standstill at a traffic light intersection or when it comes to a standstill in stop & go traffic. This is in line with the driver's wish not to create too many gaps that could give rise to misinterpretations by the following traffic. For example, the following traffic is worried about not being able to pass the traffic light intersection during the following green phase or assumes that there is a breakdown in the vehicle ahead, etc. The drivers of the vehicles of the following traffic then strive to overtake the vehicle ahead. The method according to an embodiment of the invention offers the driver the possibility of preventing other vehicles from constantly entering the gap. This can be done in such a way that the automatic mode in which the distance to the vehicle ahead is controlled is not interrupted at all. Thus embodiments of the invention provides an increase in comfort for the driver. The range of applications of the adaptive cruise control system is expanded.

An advantageous embodiment of a method according to the invention is to further measure the distance to the vehicle ahead and to pre-select the drive torque for the acceleration process as a function of the measured distance between the ego-vehicle and the vehicle ahead. If there is a greater distance, for example 10 m, the gap can be closed at a greater speed than with a small distance. This is also practical and corresponds to the typical driving behavior of most drivers.

In a more specific design, it is advantageous that at a measured distance between the ego-vehicle and the vehicle ahead that is assigned to a close range, the drive torque for the acceleration process is selected in such a way that the ego-vehicle approaches the vehicle ahead at crawling speed. The close range can be flexibly defined depending on the vehicle. For commercial vehicles, it is advisable to select the close range for gaps in the range of, for example, 5-3 m. In the case of a commercial vehicle, crawling speed is associated with the fact that a corresponding crawler gear is engaged in the transmission and a corresponding drive torque for the acceleration process is applied to the drive unit. As a result, the commercial vehicle moves forward very slowly. This measure also serves to prevent the gap to the vehicle ahead from being closed at too high a speed and to reduce the risk of falling below the safety distance. This may then trigger violent braking. The measure also increases the comfort for the driver and possibly for passengers. In addition, less fuel is consumed or the vehicle's drive battery is conserved.

Another advantageous measure is that in order to cancel the increase in drive torque, the drive torque is set to zero when the vehicle ahead comes to a standstill, wherein the service brake of the ego-vehicle is also applied to stop the ego-vehicle. This also has the advantage of preventing falling below the safety distance. In particular, if the gap has already been closed to such an extent that the distance between the ego-vehicle and the vehicle ahead is already close to the safety distance, the vehicle would continue to roll when the drive torque was switched off and the distance would quickly become less than the safety distance.

In this regard, an advantageous measure is that if the ego-vehicle has approached the vehicle ahead up to the safety distance, an additional warning is issued to the driver of the ego-vehicle.

The warning to the driver of the ego-vehicle can be issued in the form of a warning display on a display unit and optionally augmented with an output of an audible warning or output in haptic form.

A variant of carrying out a haptic warning is to cause vibration of the steering wheel.

A further embodiment of the invention consists of a device for controlling the distance between an ego-vehicle and a vehicle ahead, wherein the ego-vehicle is equipped at least with a braking system, a drive system and an adaptive cruise control system with an operating unit. Here maintaining an entered minimum distance is controlled by the adaptive cruise control system. This embodiment of the invention is characterized in that the adaptive cruise control system has an electronic processing unit connected via one or more communication buses at least to an electronic control unit of the drive system and an electronic control unit of the braking system and an operating unit. The electronic processing unit is set up to send a command to increase the drive torque of the drive system to the electronic control device of the drive system after operating an operating element of the operating unit in order to cause an acceleration of the ego-vehicle in the forward direction. Before that, a command to release the holding function of a brake of the braking system (BS) is sent to the electronic control unit (CU5) of the braking system (BS). Typically, the holding function is realized by activating the service brake. Here the adaptive cruise control system has a distance measurement system for measuring the distance between the ego-vehicle and the vehicle ahead. The processing unit is also set up to send a command to the electronic control unit of the drive system to cancel the increase in drive torque when a predefined reduction distance to the vehicle ahead is reached and, optionally, to send a command to the electronic control unit of the braking system to operate a service brake of the braking system. The increase in drive torque can be cancelled by sending a new command to set the drive torque to a correspondingly lower value or the value zero.

It is also advantageous for the device if a radar sensor, a lidar sensor or a camera sensor or a combination of these sensors is provided as a distance measurement system. The camera can be used, for example, to check the plausibility of object detections on the part of the radar system. This makes it easier to determine what the type of vehicle ahead is. The camera is also used, for example, to control lane keeping if the vehicle is equipped with a lane keeping assistance system. The lidar sensor can also be used to check the plausibility of object detections. There is also the possibility of using the technology for sensor fusion. With this, in some situations, the accuracy of the classification of objects can be increased. This is always advantageous if there are deteriorated measurement conditions for one of the sensors. The weather conditions are crucial here. In the dark, it is difficult to evaluate the camera images for distance calculation. In rain, fog and snowfall, the accuracy of lidar sensors may be compromised. But also that of the camera.

In an embodiment of the device according to the invention, the operating unit consists of a steering wheel operating unit of a multifunction steering wheel of the ego-vehicle. Such steering wheel operating units are already being used in an advantageous way to operate ACC systems. They can be operated very conveniently by the driver without the driver being distracted from observing the traffic situation.

In this regard, it is advantageous if the function for requesting an increase in the drive torque of the drive system is assigned to a resume button of the operating unit of the adaptive cruise control system. This button typically has the function of resuming automatically controlled operation after the driver has temporarily taken control himself. The resume key can also be used advantageously for the application with the an embodiment of invention. By pressing the resume button, the driver can request the gap to the vehicle ahead to be closed. To do this, however, a distinction must now be made as to whether the ACC button was pressed to resume the ACC function or to reduce the distance. This can be done simply by measuring the speed of the vehicle. If the vehicle is stationary and the resulting distance to the vehicle ahead is within certain limits, it can be assumed that the vehicle is in a traffic jam or in stop & go traffic and the function to close the gap can be called up.

A further embodiment of the invention consists of a vehicle equipped with an electronically controlled braking system and an adaptive cruise control system, which has a device according to an embodiment of the invention as a further feature.

Finally, an embodiment of the invention also comprises an electronic processing unit which can be connected via one or more communication buses to an electronic control unit of the drive system and an electronic control unit of the braking system and a distance measurement system, and which is set up to communicate with the electronic control unit of the drive system, and the electronic control unit of the braking system. This is used to receive measured distance values and to transmit control commands to the electronic control unit of the braking system and the electronic control unit of the drive system in such a way that a method according to an embodiment of the invention can be carried out. This electronic processing unit has the same advantages as explained in connection with a method according to an embodiment of the invention and the device according to an embodiment of the invention.

Exemplary embodiments of the invention are shown in the drawings and are explained in more detail below by means of the figures.

The present description illustrates the principles of the disclosure according to embodiments of the invention. It is therefore understood that those skilled in the art will be able to conceive various arrangements which, although not explicitly described herein, embody principles of disclosure according to the invention and are also intended to be protected in their scope.

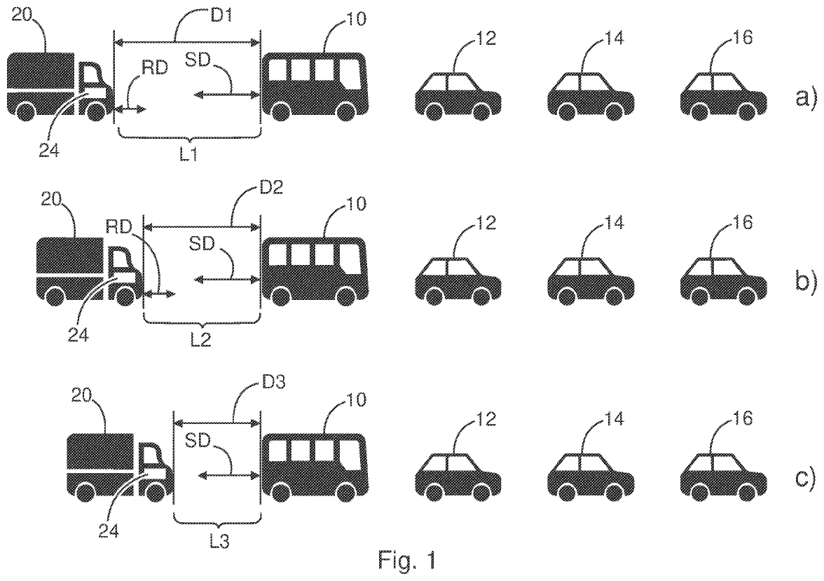

FIG. 1a shows the typical traffic situation when approaching the end of a traffic jam. The approaching vehicle 20 is a commercial vehicle in the form of a truck. The vehicle 10 driving directly ahead of the truck 20 is a bus 12 that has already reached the end of the traffic jam and come to a standstill. In front of the bus 12 there are other vehicles 14, 16, 18 that have come to a standstill. The ACC system of the truck 20 is equipped with a stop & go function. The driver has set the smallest minimum distance D1. For this purpose, it is explained that with an adaptive distance control system, the distance is dynamically controlled as a function of the speed. For this reason, no absolute distance values are offered to the driver on the user interface for selecting the minimum distance. Often, only a numerical list of possible settings is offered. The choice does not correspond to a fixed distance. More precisely, the choice corresponds to the time that the ego-vehicle (20) would need at the current speed to drive the distance corresponding to the currently existing distance to the vehicle ahead.

The ACC system of the commercial vehicle 20 offers a choice of 5 possible settings for the distance control. The largest value can correspond to the largest distance. The smallest value can correspond to the smallest distance. If the vehicle comes to a standstill, whether in front of a traffic light intersection, in a traffic jam or during stop & go traffic, a stopping distance of for example 5 m to the vehicle ahead can be maintained for all setting values. This can also depend on the load condition of the truck 20. This is because the braking distance will change greatly if, for example, the vehicle is fully loaded to 40 tonnes compared to a vehicle driving without a load. A gap L1 to the vehicle ahead 10 of a minimum of 5 m is then maintained. This gap L1 also persists when the vehicle 20 comes to a standstill. The gap L1 shown in FIG. 1a has a length of 5 m. Also shown is the safety distance SD, which is fixed in the system for traffic situations such as city traffic with traffic light intersections, traffic jams and stop & go traffic. For safety reasons, the distance must not fall below this safety distance SD. FIG. 1a also shows a reduction distance RD that is predefined in the ACC system.

This gap L1 is entered by other vehicles, especially on multi-lane roads. This leads to “gap hopping”. This behavior can be observed in many countries. Drivers of smaller vehicles who are in a hurry are often prone to this behavior. However, there are also dangers associated with this. An inattentive driver must brake abruptly to prevent a collision with the intruding vehicle. The ACC system will then react in such a way that it also initiates a braking process in order to be able to maintain the set minimum distance D1 again. Then the gap L1 occurs again that another vehicle can enter.

With the solution according to embodiments of the invention, the gap can be reduced without the ACC system exiting from automatic control, so that fewer overtaking vehicles will take advantage of it to change lanes. FIG. 1b shows the distance after the first step in order to reduce the occurring gap L1. The driver can trigger this process manually if he wishes. To do this, he presses a button on a multifunction steering wheel operating unit. Alternatively, it would also be possible to use the gas pedal or acceleration pedal as an operating element. Tapping the accelerator pedal or gas pedal could then prompt the closure of the gap.

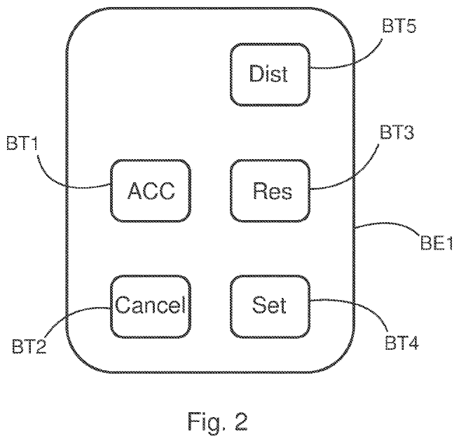

FIG. 2 shows the multifunction steering wheel operating unit BE1. In addition to the multifunction steering wheel operating unit BE1, other multifunction steering wheel operating units can be attached to the multifunction steering wheel. These may be provided for the operation of additional assistance functions. The multifunction steering wheel operating unit BE1 is used to operate the ACC system. The operating button BT1 can be used to switch the function of the ACC system on and off. With the operating button BT2, the automatic speed and distance control can be interrupted for a short time. But this also happens when the driver presses the brake pedal. By pressing the operating button BT3, the automatic speed and distance control is resumed. The operating button BT3 is also used to give the command to close the gap to the vehicle ahead 10 to the ACC system ACCS when the ego-vehicle 20 is at a standstill. This will request the closing of the gap by a certain amount, such as 1 m. The reduction distance RD is then 1 m. When the operating button is pressed again, the gap is closed further. It is therefore possible to press the operating button several times, provided that the minimum safety distance has not yet been reached.

The vehicles are typically also equipped with a speed control system CC, corresponding to cruise control. With this, the control speed can typically also be adjusted incrementally. However, this is done with a separate steering wheel operating unit.

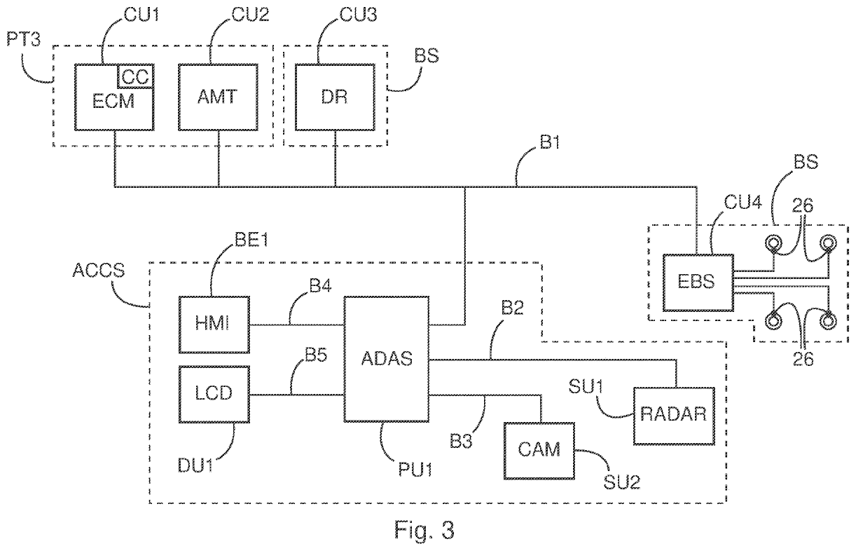

By pressing the operating button BT1, control is transferred to the ACC system ACCS. When the ACC system is switched on, the operating button BT4 is used to set the instantaneous speed of the vehicle 20 as the target speed for the cruise control system. The operating button BT5 can be used to select different distance values for the distance control system. For example, the ACC system predefines 5 setting options. Pressing the operating button BT5 changes the selected value. The currently selected value is displayed in an operating menu on a display unit. The display unit is installed either in the cockpit's instrument cluster or in a separate location in the cockpit. This is explained in more detail in connection with FIG. 3. When the operating button BT5 is pressed, the next entry in the list of setting options is selected. The list is run through cyclically when the operating button BT5 is pressed multiple times. When the last entry in the list is reached, a return to the beginning of the list is caused when the operating button BT5 is pressed again. The driver sees on the display unit which entry in the list he has selected by pressing the operating button BT5. This value is then taken up by the ACC system as the newly set minimum distance. Typically, the display unit DU1 also shows the current distance to the vehicle 10 ahead.

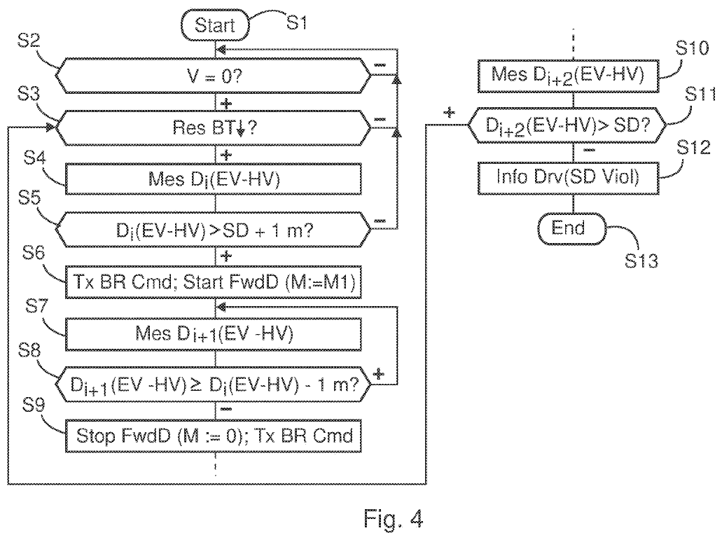

In FIG. 1b it can be seen that the minimum distance has been reduced by pressing the operating button BT3 once. The reduced minimum distance is marked in FIG. 1b with reference sign D2. In the case shown, the minimum distance was reduced from 5 m to 4 m. This is where the predefined reduction distance RD comes into play. How the corresponding control is carried out by the ACC system in order to reduce the distance in this way will be explained later in conjunction with FIG. 4. Thus, if the operating button BT3 is pressed once, the minimum distance D1 is reduced from the value of 5 m to the new minimum distance D2 of 4 m. It is also shown that the fixed safety distance SD of 2 m is still maintained.

FIG. 1c shows a second step for closing the gap L1. To do this, the driver presses the operating button BT3 a second time. In the ACC system according to an embodiment of the invention, this leads to a further reduction of the newly set minimum distance D2. For this purpose, the same operation is performed again. The distance is reduced again by the same reduction distance RD. As a result, the gap L2 is reduced again. The gap L3 is created with a minimum distance D3 of only 3 m. Even with the gap L3, the safety distance SD is still maintained. If the driver were to press the operating button BT3 a third time, the L3 gap would not be closed any further. This is because the distance to the vehicle ahead 10 is measured continuously. If it is determined that the difference between the set minimum distance D3 and the safety distance SD is less than approx. 1 m, the requested reduction step will no longer be implemented. At the same time, a warning message will be issued to the driver. The possible warnings are explained in more detail in connection with the description of FIG. 4.

FIG. 3 shows the structure of an exemplary vehicle electronic system of the vehicle 20. Various electronic control units are provided. Block CU1 refers to an electronic engine control system (ECM), corresponding to “Engine Control Module”. Block CU2 refers to an automatic transmission control unit AMT, corresponding to “Automated Manual Transmission”. Block CU3 refers to an electronic control unit of the retarder unit. This is used to support a braking process and can prevent overheating of the friction brakes on the wheels. Block CU4 refers to an electronic brake control unit EBS, corresponding to “Electronic Braking System”. The reference number 26 represents a service brake per wheel. Each service brake 26 can be operated separately by the electronic brake control unit EBS. For this purpose, the corresponding brake lines are connected to the electronic brake control unit EBS. The braking system BS contains both the retarder unit CU3 and the electronic brake control unit EBS.

Part of the electronic engine control unit is also the cruise control system CC, corresponding to cruise control.

Block PU1 refers to an electronic processing unit of a driver assistance system ADAS, corresponding to “Advanced Driving Assistance System”. It is the aforementioned ACC system, i.e. the automatic distance control system that automatically maintains the distance to the vehicle ahead 10. Other components that form the ACC system ACCS together with the processing unit PU1 are connected to the processing unit PU1.

The reference sign BE1 refers to the steering wheel operating unit already mentioned. The steering wheel operating unit BE1 is connected to the processing unit PU1 via a bus line B4. The well-known LIN bus, corresponding to the “Local Interconnect Network” bus, is used for this purpose, for example.

The reference sign DU1 refers to the display unit already mentioned. This is advantageously arranged as a touch-sensitive display unit (touchscreen) in the cockpit of the commercial vehicle 20. This allows a wide range of operations to be carried out. For this purpose, operating menus are displayed on the display unit DU1. The driver can select menu items, change parameter settings and make entries, as is known from smartphones or tablets, for example. The display unit DU1 is connected to the processing unit PU2 via a bus connection B5. This is used to transmit the display data and to transfer the operating commands and inputs entered by the driver from the display unit DU1 to the processing unit PU1. As an example, the LVDS bus system is mentioned, corresponding to (Low Voltage Differential Signal), which was developed for these purposes and can be used here.

Furthermore, the processing unit PU1 is connected to a number of environment detection sensors. As an example, FIG. 3 shows a camera SU2 and a radar sensor SU1. The camera SU2 can be equivalent to a standard video camera. Both sensors, radar sensor SU1 and camera SU2, are connected to the processing unit PU1 via a separate bus connection B2 and B3. Alternatively or additionally, a lidar sensor, one or more IR cameras, and one or more ultrasonic sensors can be connected for environment detection. As a suitable bus system that is suitable for the transmission of camera data and radar data and lidar data, the Automotive Ethernet bus system in the IEEE 1000Base-T variant is mentioned as an example. It meets the increased bandwidth requirements required for such sensors.

The electronic control units CU1 to CU4 and the electronic processing unit PU1 are networked with each other via a bus system B1. For this purpose, a bus system designed for in-vehicle communication can be used. Typically, serial bus systems are used for this purpose, as they require the least amount of cabling. A possible example is a CAN bus system, corresponding to Controller Area Network. There are different variants of the CAN bus system such as CAN Low Speed and CAN High Speed for different data rates from 125 kbit/s up to 1000 kbit/s. Furthermore, an extended CAN bus was specified under the name CAN-FD bus, where FD stands for “Flexible Data Rate”. This specification defines an extended data frame with higher transport capacity, where the payload field is enlarged. Other automotive bus systems are known under the names Flexray and Automotive Ethernet, which can also be used for networking the electronic control unit. The bus architecture is shown in FIG. 3 for the bus B1 in such a way that a common bus line is used. Deviating from this type of representation, it is also possible to provide several different bus lines for this purpose, wherein only selected control units are connected to one of these bus lines. This is particularly necessary if the data rate is not sufficient to supply all control units with data at the same time via one bus line. In order for the data to be able to be forwarded to other control units, it is then necessary to provide one or more gateway stations that can receive the data via a connected bus and forward it to another bus. If the two bus systems for reception and forwarding are different bus systems, the gateway station is set up to perform the necessary protocol conversion.

The operation of the vehicle electronics to reduce the minimum distance D1 set in the ACC system ACCS is now explained using the flow diagram in FIG. 4.

The program is started in program step S1 when the ACC system ACCS has detected that the vehicle is moving in a traffic jam or in stop & go traffic. This detection is built into well-known ACC systems. For this purpose, the image data of the camera SU2 or the radar sensor SU1 and the data regarding vehicle speed and the frequency of starting the vehicle are evaluated. The data of a navigation system can also be used for this purpose.

In program step S2, it is checked whether the commercial vehicle 20 remains at a standstill. If not, the program jumps back to the beginning and continues to wait for the vehicle to come to a standstill. When the vehicle is at a standstill, query S3 checks whether the operating button BT3 has been pressed. If not, the program jumps back to the beginning. Once the operation of the operating button BT3 has been detected, the distance D1 between the truck 20 and the vehicle ahead 10 is measured again in program step S4. This measured distance is evaluated in the next program step S5. It is checked whether the measured distance meets the condition that it is greater than the prescribed safety distance SD plus the set reduction distance RD. The reduction distance RD was set to 1 m in the flowchart shown. Alternatively, a different value can be predefined here. For example, the value 0.5 m could be set in the program. Alternatively, it is also possible to design the program to be configurable. A user would then have the option to select a value. At least for test drives, it is advantageous if this value could be adjusted. For safety reasons, however, only the test personnel would have access to this setting option, but not the future customer of the production vehicle. If the check in program step S5 shows that the current distance does not meet this condition, the program branches back to the beginning. If the condition is met, the first step to reduce the distance is carried out. For this purpose, in program step S6, a command is sent to the engine control unit CU1 with a request for an engine torque M:=M1. Typically, the engine control unit CU1 selects the appropriate gear for starting and sends the corresponding command to the transmission control unit CU2. Alternatively, the gear selection can be made by the processing unit PU1 and the processing unit PU1 then sends the appropriate command to the transmission control unit CU2. The clutch can also be controlled by the engine control unit. Before that, a brake command is sent to the brake control unit CU4. This command is used to release the holding function of the service brake, which is operated for safety reasons when the vehicle 20 is at a standstill and secures the commercial vehicle 20 against rolling away. When the command to set an engine torque is implemented by the engine control system CU1 and the vehicle 20 is accelerated. The engine torque is requested in the way required to close the occurring gap. If the gap is very small, for example only 3 to 5 m, everything is adjusted to result in a crawling speed for the vehicle 20. In this way, the gap L1 between the commercial vehicle 20 and the bus 10 is closed carefully. In program step S7, the distance to the vehicle ahead 10 is measured. In program step S8, the measured distance value is evaluated. For this purpose, a query is made as to whether the newly measured distance value Di+1 is greater than the distance value Di measured in program step S4 minus the reduction distance RD. If so, the distance can be reduced even further and the program branches back to program step S7. If the condition is no longer met, the vehicle has moved far enough and the vehicle is stopped in program step S9. To do this, the processing unit PU1 sends a command to the engine control unit CU1, which means that the engine torque is reset to zero (M:=0). A brake command is also sent to the electronic control unit CU4 of the braking system (BS). When this command is implemented by the electronic control unit CU4, the vehicle 20 is braked gently. In addition, in the next program step S10 the distance is measured again. This measurement result is evaluated in program step S11. If it is determined here that the vehicle 20 has already reached or fallen below the safety distance SD, a warning is issued to the driver in program step S12. This is displayed on the display unit DU1. Optionally, an audible warning can also be issued via the loudspeakers of the vehicle. Alternatively, the warning can be issued in haptic form. In one variant, this can be done by causing vibration of the steering wheel. After that, the program ends in program step S13 and control is transferred to the driver.

All examples mentioned herein, as well as conditional formulations, are to be understood without limitation to such specifically cited examples. For example, it is acknowledged by experts that the block diagram presented here is a conceptual view of an exemplary circuit arrangement. Similarly, it can be seen that a flowchart, state transition diagram, pseudocode, and the like represent various variants for representing processes that are essentially stored in computer-readable media and thus can be executed by a computer or processor.

It should be understood that the disclosed method and related devices can be implemented in various forms of hardware, software, firmware, special processors or a combination thereof. Special processors may include application-specific integrated circuits (ASICs), reduced instruction set computers (RISC), and/or field programmable gate arrays (FPGAs). Preferably, the disclosed method and device are implemented as a combination of hardware and software. The software is preferably installed as an application program on a program storage device. Typically, it is a machine based on a computing platform that has hardware, such as one or more central processing units (CPU), direct access memory (RAM), and one or more input/output (I/O) interfaces. An operating system is also typically installed on the computer platform. The various processes and functions described here can be part of the application program or a part that is executed by means of the operating system.

The disclosure is not limited to the exemplary embodiments described herein. There is room for various adjustments and modifications that the person skilled in the art would consider on the basis of his expertise as also belonging to the disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

10 bus
12 automobile ahead
14 automobile
16 automobile
20 commercial vehicle
24 internal combustion engine
26 service brake
ACCS adaptive speed control system
B1 1st communication bus
B2 2nd communication bus
B3 3rd communication bus
B4 4th communication bus
B5 5th communication bus
BE1 operating unit
BT1 ACC mode on/off operating button
BT2 ACC mode interrupt operating button
BT3 resume operating button
BT4 setting operating button
BT5 select distance operating button
BS braking system
CU1 electronic engine control unit
CU2 electronic transmission control unit
CU3 electronic retarder control unit
CU4 electronic brake control unit
D1 minimum distance
D2 reduced minimum distance
D3 further reduced minimum distance
DU1 display unit
Li gap
L2 reduced gap
L3 further reduced gap
M1 1st drive torque
M2 2nd drive torque
PTS drive system
PU1 electronic processing unit (virtual driver)
RD reduction distance
SD safety distance
SU1 radar sensor
SU2 camera
S1-S13 different program steps of a computer program

1: A method for controlling a distance between an ego-vehicle and a vehicle ahead, wherein the ego-vehicle is equipped with at least one braking system, a drive system and an adaptive cruise control system with an operating unit, the method comprising:
maintaining an entered minimum distance that is controlled by the adaptive cruise control system wherein when the ego-vehicle is at a standstill, a reduction of the entered minimum distance is made possible by user input by the operating unit;
releasing, after operating an operating element, holding function of the braking system and increasing a drive torque of the drive system in order to cause the ego-vehicle to accelerate in a forward direction;
continuously measuring a distance to a vehicle ahead; and
when a predefined reduction distance or a predefined safety distance to the vehicle ahead is reached, canceling the increase in drive torque.

2: The method as claimed in claim 1, wherein the distance to the vehicle ahead is measured and the drive torque for the acceleration process is selected as a function of the measured distance to the vehicle ahead.

3: The method as claimed in claim 2, wherein at a measured distance between the ego-vehicle and the vehicle ahead that is assigned to a close range, the drive torque for the acceleration process is selected in such a way that the ego-vehicle approaches the vehicle ahead at crawling speed.

4: The method as claimed in claim 1, wherein for the cancellation of the increase in the drive torque, the drive torque is set to zero when the vehicle ahead comes to a standstill, and wherein in addition the service brake of the ego-vehicle is operated to stop the ego-vehicle.

5: The method as claimed in claim 4, wherein if the ego-vehicle has approached the vehicle ahead up to the safety distance, in addition a warning is issued to the driver of the ego-vehicle.

6: The method as claimed in claim 5, wherein the warning is issued to the driver of the ego-vehicle in the form of a warning display on a display.

7: A device for controlling a distance between an ego-vehicle and a vehicle ahead, wherein the ego-vehicle is equipped at least with a braking system, a drive system and an adaptive cruise control system with an operating unit,
wherein maintaining an entered minimum distance is controlled by the adaptive cruise control system,
wherein the adaptive cruise control system has a processor which is connected via one or more communication buses at least to a controller of the drive system and a controller of the braking system and an operating unit,
wherein the processor is configured to, after an operating element of the operating unit is operated, send a command to release a holding function of the braking system to the controller of the braking system and to send a command to increase the drive torque of the drive system to the controller of the drive system in order to cause the ego-vehicle to accelerate in a forward direction,
wherein the adaptive cruise control system also has a distance measurement system for measuring a distance between the ego-vehicle and the vehicle ahead,
wherein the processor is further configured to send a command to the controller of the drive system with which the increase in the drive torque is cancelled when a predefined reduction distance from the vehicle ahead is reached or when a predefined safety distance is reached.

8: The device as claimed in claim 7, wherein a radar sensor, a lidar sensor or a camera sensor equipped with a stereo camera, or a combination thereof, is provided as the distance measurement system.

9: The device as claimed in claim 7, where the operating unit is a steering wheel operating unit of a multifunction steering wheel of the ego-vehicle.

10: The device as claimed in claim 9, wherein the function for requesting an increase in the drive torque of the drive system is assigned to a resume button of the operating unit of the adaptive cruise control system.

11: A vehicle with a drive system, an electronically controlled braking system and an adaptive cruise control system, the vehicle comprising the device as claimed in claim 7.

12: A processor, which can be connected via one or more communication buses to a controller of the drive system and a controller of the braking system and a distance measuring system and which is set up to communicate with the controller of the drive system and the controller of the braking system in order to receive measured distance values and to send control commands to the controller of the braking system and the controller of the drive system in such a way that the method as claimed in claim 1 carried out.

13: The method as claimed in claim 1, further comprising operating a service brake of the braking system in order to stop the ego-vehicle when a predefined reduction distance or a predefined safety distance to the vehicle ahead is reached.

14: The method as claimed in claim 6, wherein the warning issued to the driver of the ego-vehicle is augmented with an output of an audible warning or is issued or augmented in haptic form.

15: The device of claim 7, wherein the processor is further configured to send a command to the controller of the braking system, with which a service brake of the braking system is operated.
